(19) United States
(12) Patent Application Publication
(10) Pub. No.: US 2011/0178818 A1
(43) Pub. Date: Jul. 21, 2011

(54) ACTIVITY LOG SYSTEM

(76) Inventor: Jorgen Jonsson, Lund (SE)

(21) Appl. No.: 13/119,976

(22) PCT Filed: Sep. 2, 2009
(86) PCT No.: PCT/EP2009/061352

§ 371 Date: Mar. 21, 2011

(30) Foreign Application Priority Data
Sep. 19, 2008 (EP) 08105394.4

(51) Int. Cl. G06Q 50/00; G06Q 10/00

(52) U.S. Cl. 705/2

(57) ABSTRACT

An activity log system for patient handling equipment, for example a hoist, comprises an accelerometer (3) mounted on the patient handling equipment (10, 11, 12, 13). The accelerometer together with a microprocessor logs data over time, so that movement of the equipment is measured and recorded. The data collected is transmitted to a main control unit (15), in contact with other activity log systems (1), which matches logged data with experience data to enable mapping of equipment usage over time.

The present invention relates to a log system for patient handling equipment, in particular the logging of specific activities carried out using patient lifting and handling equipment.

Most of the careers working in healthcare today are aware of the need of mechanical aids when lifting and transferring patients. Even with this awareness careers have problems with back injuries.

There is a need for the hospitals to minimise these problems by investigating whether the hospital has the right mechanical aids, whether they have enough equipment, and equipment that is easy to use with the right level of education and training for the careers and whether these processes are in place at the establishment.

Many care facilities are planning to invest further in programs and equipment in order to reduce back injuries among their employees. One way of ensuring that the hospitals invest money in the right processes, equipment and training would be to monitor the usage of patient handling equipment throughout a care facility over time, and based on that guide decide on how best to improve the processes, equipment and training.

It is known to have patient handling equipment equipped with data logging for the purpose of servicing the equipment, but this information is difficult to collect for any other person other than the service personnel. It is known to have sensors associated with exercise equipment that records the extent of exercise undertaken by the user using the equipment.

The present invention seeks to make improvements.

Accordingly, the present invention provides an activity log system for patient handling equipment, comprising at least one sensor attached to a patient handling equipment, the sensor arranged to provide data relating to the use of the equipment characterised in that the system includes a control unit that compares the use data against experimentally derived data to identify a specific activity carried out using the equipment.

Since the sensor system is independent of the patient handling equipment, it is possible to collect a coherent data set regarding usage with type of mechanical aids, such as, for example, floor lifters, ceiling lifters, lateral transfer devices, sliding sheets, standing and raising aids, shower chairs, bathsystems and trolleys, in a care facility, independent of the patient handling equipment brand or model, without compromising the patient handling equipments' integrity.

Preferably, the sensor system comprises a control unit collecting measured data from a plurality of sensors, such as for example, accelerometer devices, gyroscopic devices, microphone devices, hall effect devices, strain gauge devices, light sensing devices or camera devices attached to a patient handling equipment.

One or several secondary indicators are used to form a pattern that is interpreted by the control unit and matched against experience values and rules to determine if a certain activity has taken place. Specific activities to be measured could be for example, a patient transfer from one surface to another, a repositioning of a patient, a wound dressing event of a patient, a transport of the equipment to a storage place, a mechanical aid feature usage.

In a preferred embodiment of the invention, the sensor system comprises an accelerometer with a microprocessor and a transceiver powered from a power source mounted on the equipment, the accelerometer data relating to movement of the equipment collected and interpreted by the microprocessor by comparison with experimentally derived data to identify a specific activity carried out using the equipment.

The invention answers the need for identifying the kind of activity undertaken with a piece of equipment.

The system is not tied to a specific product, since it is an autonomous device. The sensor system can be added to any lift equipment without any influence on the medical device operation. The data is made readily accessible to a main control unit.

Preferably, a main control unit, in contact with the autonomous activity log units, matches logged data with extended data, such as number of personnel and patients at a given time, to provide equipment usage information.

The system sorts out a unique pattern that matches the activity to be monitored. This pattern is built on experience values from trials, the number of trials determining the accuracy of the system.

Specific activities could be:
A complete patient transfer
A repositioning of a patient
A limb holding event of a patient
A short movement without patient involvement
A transport of the equipment to a storage place

Measuring data could be:
Accelerometer data
Gyroscopic data
Microphone listening for sound from the actuator motor
Hall effect device sensing the magnetic field generated by the actuator motor

Collected data that is written to a log could be (but not limited to):
Sort of event identified
Time of day and date
ID-number of equipment
Event length

Typically, the system can be used for the mapping of equipment usage within a ward over time for personnel education planning, or for Safe Patient Handling Act legislation, or maintenance planning, or equipment purchase planning, or improvements for research and development feedback.

An embodiment of the invention will now be described with reference to the following drawings, of which:

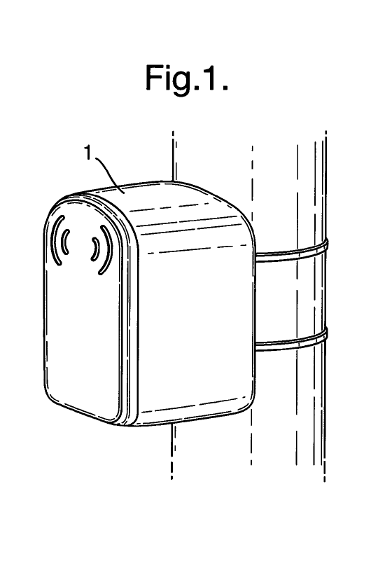

FIG. 1 is a schematic of an accelerometer as used as a sensor attached to a mast of a hoist;

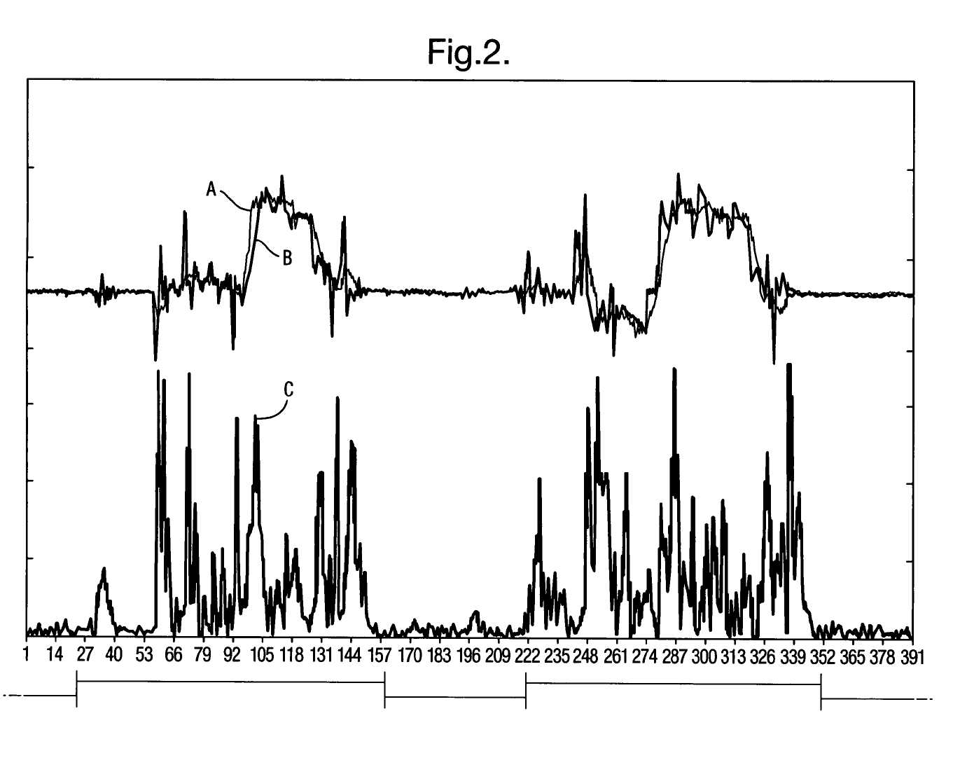

FIG. 2 shows a trace of comparison of accelerometer readings during activities and no activity; and

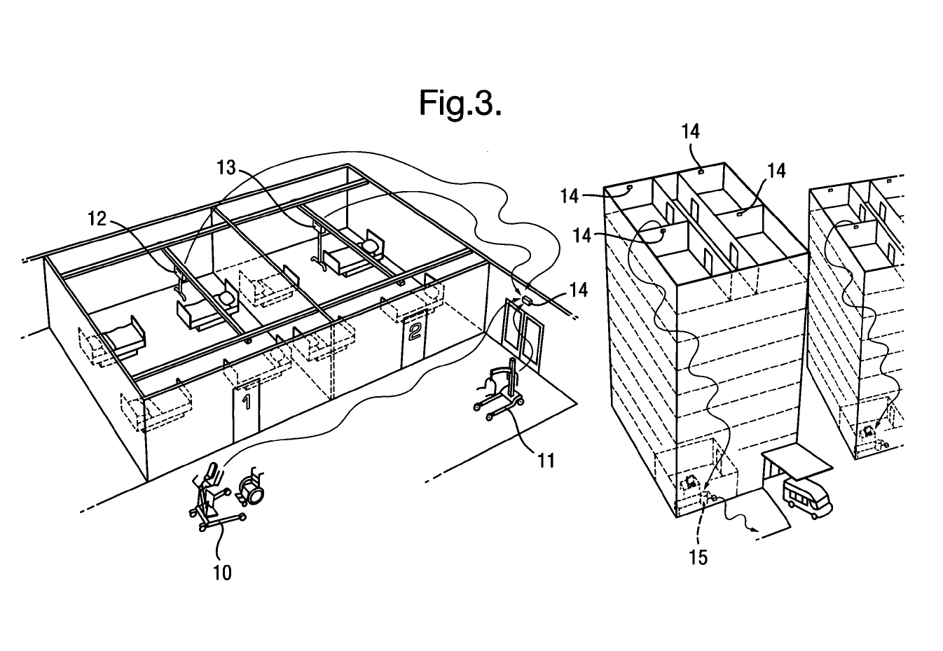

FIG. 3 shows a schematic of the activity log sensor system as used on a ward.

Referring to the Figures, an activity log unit 1 including an a 3 axis accelerometer is mounted on the mast of a hoist as shown in FIG. 1, the unit collecting measuring data 2 over time without compromising the function or integrity of the supervised equipment. The data collected is independent of mounting direction and placement on the equipment to be monitored, and it is not bound by any interface with any motors, hand controls or slings on the equipment. The activity log unit 1 can be transported between wards with the equipment. The activity log unit 1 includes an accelerometer together with a microprocessor and a transceiver powered from a power source, this unit can have further functions such as buttons and/or displays.

As shown in FIG. 2, the accelerometer in the activity log units 1 is polled in time intervals, the fetched accelerometer data, representing acceleration in g, is compared with time delayed data from the same accelerometer, when movement is introduced these two values A and B will differ much more than a non-moving accelerometer, value C. By comparing the two and introducing filters, a data vector representing the movement over time of the accelerometer is formed. The rules for interpreting all patient handling equipment are stored in the processor unit. This data vector can be compressed and sent to a main control unit over radio in several steps to reach the main control unit for further interpretation.

The microprocessor in the activity log unit 1 also runs a program that determines the different power modes of the unit, based upon accelerometer data, to conserve energy.

The main control unit 15 time stamps all incoming data, making the need of a real time clock and calendar in each unit unnecessary. An example is shown in FIG. 3, where the main control unit 15 is in contact with the autonomous activity log units on the ceiling and floor hoists 10, 11, 12, 13, by radio-communication 14 or other suitable techniques.

The main control unit 15 stores all relevant data from the data collecting units 10, 11, 12, 13. The control unit 15 can hold information on where a specific activity log unit 1 is installed, at which location and on what type of patient handling equipment. The data from the activity log units is stored together with time and date of the activity. The main control unit 15 matches derived sensor data 11, 12, 13, 14 from the activity log units 1 against experience data to sort out a specific activity. The resulting file then contains data that can be analyzed on its own or to be combined with data from other sources to gain knowledge of how patient handling equipment is utilised throughout a facility.

1. An activity log system for a patient handling equipment, comprising at least one sensor attached to a patient handling equipment, the sensor arranged to provide data relating to the use of the equipment characterised in that the system includes a control unit that compares the use data against experimentally derived data to identify a specific activity carried out using the equipment.

2. An activity log system as claimed in claim 1 characterised in that the sensor system comprises a control unit collecting measured data from a plurality of sensors attached to a patient handling equipment.

3. An activity log system as claimed in claim 1 characterised in that the sensor system provides a pattern of use that is interpreted by the control unit and matched against experimental data to identify the specific activity carried out using the equipment.

4. An activity log system as claimed in claim 1 characterised in that the sensor system comprises an accelerometer, a microprocessor and a transceiver powered from a power source mounted on the equipment, the accelerometer data relating to movement of the equipment collected and interpreted by the microprocessor by comparison with experimentally derived data to identify the specific activity carried out using the equipment.

5. An activity log system as claimed in claim 1 characterised in that the specific activity is a complete patient transfer.

6. An activity log system as claimed in claim 1 characterised in that the specific activity is repositioning of a patient.

7. An activity log system as claimed in claim 1 characterised in that the specific activity is a limb holding event of a patient.

8. An activity log system as claimed in claim 1 characterised in that the specific activity is storage of the equipment.

9. An activity log central system comprising a plurality of activity log systems as claimed in claim 1 characterised in that the central system matches use data from each of the activity log systems with experimental data and personnel data to provide equipment usage information.

10. An activity log system for a patient handling equipment including:
(a) a sensor system configured to:
(i) be secured to a patient handling equipment;
(ii) record readings during a trial in which the patient handling equipment is used in a manner corresponding with a specific activity to obtain experimental data;
(iii) record readings during use of the patient handling equipment by a healthcare provider to obtain usage data; and
(b) a control unit configured to compare the usage data with the experimental data to identify the specific activity for which the patient handling equipment is used by the healthcare provider.

11. The system of claim 10 wherein the control unit is further configured to:
(a) generate a sensor reading pattern representing the specific activity from the experimental data; and
(b) compare the usage data with the sensor reading pattern to identify the specific activity.

12. The system of claim 11 wherein:
(a) the sensor system includes two or more sensors configured to record data when secured to the patient handling equipment; and
(b) the sensor reading pattern is based on the data recorded by the two or more sensors.

13. The system of claim 10 wherein:
(a) the sensor system is housed in an activity log unit; and
(b) the activity log unit is configured to be separable from the patient handling equipment for securing to another equipment to be monitored.

14. The system of claim 13 wherein the activity log unit is configured to receive power from a power source mounted on the patient handling equipment.

15. The system of claim 13 wherein the activity log unit does not interface with motors or hand controls on the patient handling equipment.

16. The system of claim 13 wherein the activity log unit includes a transceiver configured to transmit data to a main control unit, the main control unit being configured to communicate with multiple activity log units secured to multiple patient handling equipments.

17. The system of claim 16 wherein the main control unit is configured to match the usage data for the patient handling equipment with personnel data to provide equipment usage information, the equipment usage information identifying the patient handling equipment, the specific activity, and the healthcare provider.

18. A method of logging activity of patient handling equipment including the steps of:
(a) securing a sensor system to a patient handling equipment;
(b) obtaining experimental data by recording readings using the sensor system during a trial in which the patient handling equipment is used in a manner corresponding with a specific activity;
(c) obtaining usage data by recording readings using the sensor system during use of the patient handling equipment by a healthcare provider;
(d) comparing the usage data with the experimental data using a control unit; and
(e) identifying the specific activity for which the patient handling equipment is used by the healthcare provider using the control unit.

19. The method of claim 18 further including the step of using the control unit to:
(a) generate a sensor reading pattern representing the specific activity from the experimental data; and
(b) compare the usage data with the sensor reading pattern to identify the specific activity.

20. The method of claim 19 further including the steps of:
(a) recording data using two or more sensors in the sensor system secured to the patient handling equipment; and
(b) generating the sensor reading pattern based on the data recorded by the two or more sensors.

21. The method of claim 18 further including the steps of:
(a) housing the sensor system in an activity log unit;
(b) separating the activity log unit from the patient handling equipment; and
(c) securing the activity log unit to another equipment to be monitored.

22. The method of claim 18 further including the steps of:
(a) housing the sensor system in an activity log unit; and
(b) powering the activity log unit using a power source mounted on the patient handling equipment.

23. The method of claim 22 wherein the activity log unit does not interface with motors or hand controls on the patient handling equipment.

24. The method of claim 18 further including the step of transmitting data from the activity log unit to a main control unit using a transceiver in the activity log unit.

25. The method of claim 24 further including the steps of:
(a) using the main control unit to match the usage data with personnel data; and
(b) generating equipment usage information which identifies the patient handling equipment, the specific activity, and the healthcare provider.
